(19) United States
(12) Patent Application Publication
(10) Pub. No.: US 2017/0178493 A1
(43) Pub. Date: Jun. 22, 2017

(54) WIRELESS PAIRING SYSTEM

(71) Applicant: BENQ CORPORATION, Taipei (TW)

(72) Inventors: Lin-Yuan You, New Taipei City (TW); Chen-Chi Wu, Taipei City (TW); Shih-Han Huang, Taichung City (TW); I-Chieh Lin, Taipei City (TW)

(21) Appl. No.: 15/341,000

(22) Filed: Nov. 2, 2016

(30) Foreign Application Priority Data
Dec. 18, 2015 (TW) 104142617

(51) Int. Cl. G08C 17/02; H04W 4/00; H04W 76/02

(52) U.S. Cl. CPC G08C 17/02; H04W 76/023; H04W 4/008; G08C 2201/20

(57) ABSTRACT

A wireless pairing system includes a remote controller and at least one display device. The remote controller includes a first processing unit, an input unit and a first wireless communication unit. The input unit includes a broadcast request key and a plurality of input keys. The display device includes a second processing unit, a display unit and a second wireless communication unit. The display device has an identification code. When the broadcast request key is triggered, the first processing unit sends out a broadcast request signal through the first wireless communication unit. When the second processing unit receives the broadcast request signal through the second wireless communication unit, the second processing unit controls the display unit to display the identification code. When the input keys are operated to input the identification code of the display device, the remote controller and the display device are paired with each other.

### BACKGROUND OF THE INVENTION

1. Field of the Invention

The invention relates to a wireless pairing system and, more particularly, to a wireless pairing system capable of pairing a remote controller and a display device rapidly and conveniently.

2. Description of the Prior Art

As technology advances and develops, various display devices (e.g. television, projector, etc.) are considered a necessity by a lot of people in their daily lives. There may be a plurality of display devices installed in a specific place, so as to satisfy various display requirements. In general, a user may use one single remote controller to control all display devices in one place. In other words, when the remote controller sends out a control command, all display devices will be activated by the control command. If the user wants to use the single remote controller to control one or more than one specific display devices, he/she has to perform complicated setting operation and that will persecute the user undoubtedly.

### SUMMARY OF THE INVENTION

An objective of the invention is to provide a wireless pairing system capable of pairing a remote controller and a display device rapidly and conveniently, so as to solve the aforesaid problems.

According to an embodiment of the invention, a wireless pairing system comprises a remote controller and at least one display device. The remote controller comprises a first processing unit, an input unit and a first wireless communication unit, wherein the first processing unit is electrically connected to the input unit and the first wireless communication unit. The input unit comprises a broadcast request key and a plurality of input keys. The display device comprises a second processing unit, a display unit and a second wireless communication unit, wherein the second processing unit is electrically connected to the display unit and the second wireless communication unit. The first wireless communication unit and the second wireless communication unit communicate with each other wirelessly. The display device has an identification code. When the broadcast request key of the remote controller is triggered, the first processing unit of the remote controller sends out a broadcast request signal through the first wireless communication unit. When the second processing unit of the display device receives the broadcast request signal through the second wireless communication unit, the second processing unit of the display device controls the display unit to display the identification code. When the input keys of the remote controller are operated to input the identification code of the display device, the remote controller and the display device are paired with each other.

As mentioned in the above, when a user wants to pair the remote controller and the display device, the user may trigger the broadcast request key of the remote controller first, so as to send out the broadcast request signal to the display device. When the display device receives the broadcast request signal, the display unit of the display device will display the identification code. At this time, the user may operate the input keys of the remote controller to input the identification code of the display device, so as to pair the remote controller and the display device. Accordingly, the wireless pairing system of the invention is capable of pairing the remote controller and the display device rapidly and conveniently.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a wireless pairing system according to an embodiment of the invention.

FIG. 2 is a functional block diagram illustrating the remote controller and any of the display devices shown in FIG. 1.

FIG. 3 is a functional block diagram illustrating a remote controller and a display device according to another embodiment of the invention.

FIG. 4 is a functional block diagram illustrating the remote controller and a display device according to another embodiment of the invention.

FIG. 5 is a functional block diagram illustrating a remote controller and the display devices according to another embodiment of the invention.

FIG. 6 is a schematic diagram illustrating a wireless pairing system according to another embodiment of the invention.

### DETAILED DESCRIPTION

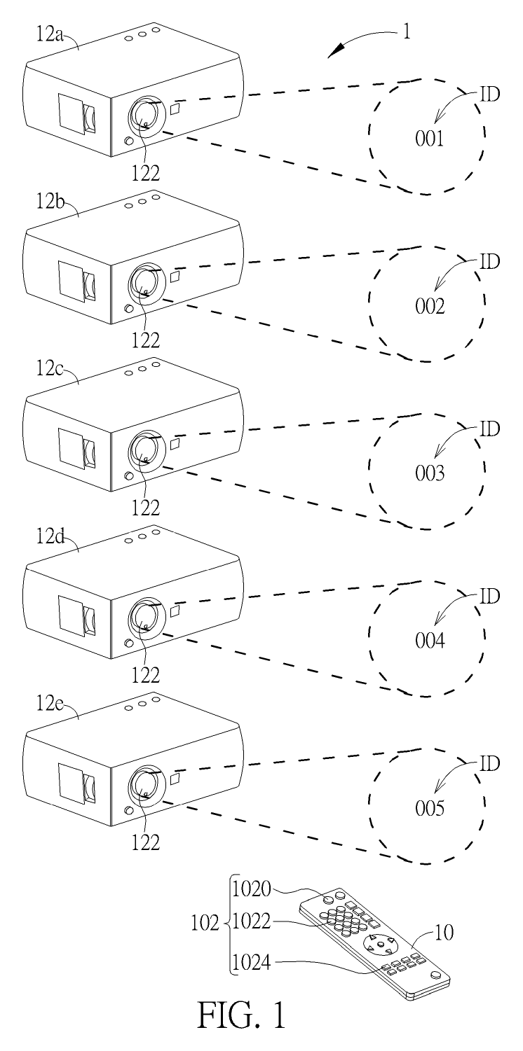

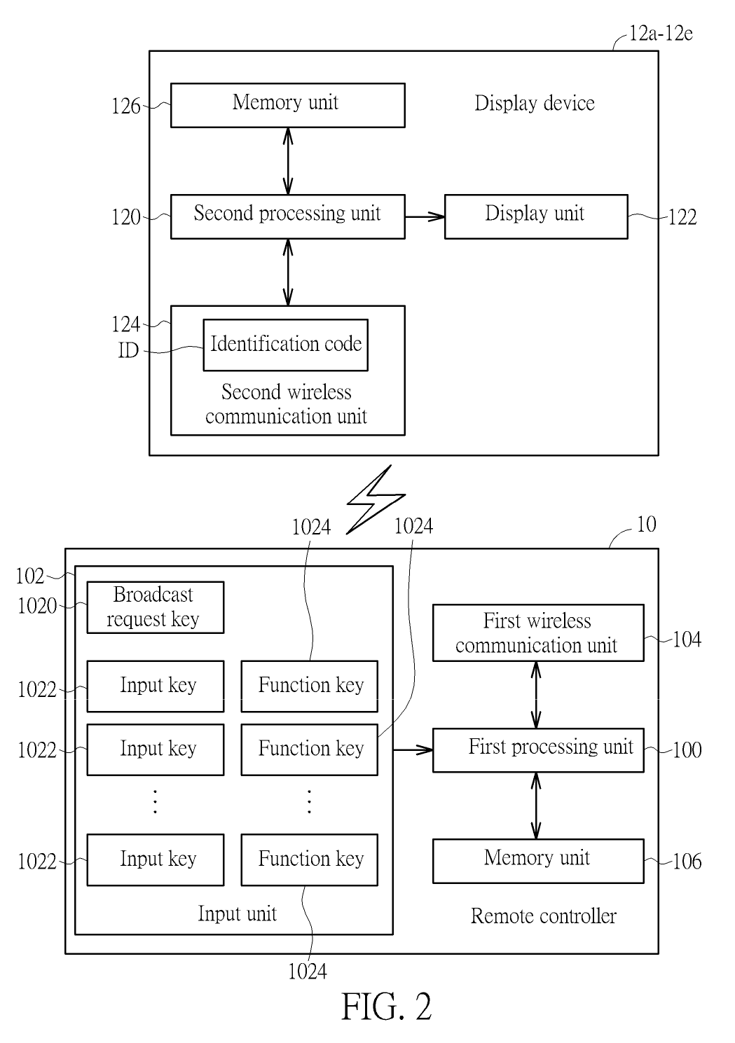

Referring to FIGS. 1 and 2, FIG. 1 is a schematic diagram illustrating a wireless pairing system 1 according to an embodiment of the invention and FIG. 2 is a functional block diagram illustrating the remote controller 10 and any of the display devices 12a-12e shown in FIG. 1. The wireless pairing system 1 of the invention comprises a remote controller 10 and N display devices, wherein N is an integer larger than 1. As shown in FIG. 1, the wireless pairing system 1 comprises five display devices 12a-12e (i.e. N=5). It should be noted that the wireless pairing system 1 of the invention may comprise one or more than one display devices and the invention is not limited to the embodiment shown in FIG. 1. In other words, the number of display devices of the invention may be determined according to practical applications. In this embodiment, the display devices 12a-12e are projectors. However, in another embodiment, the display devices 12a-12e of the invention may be televisions or other display devices, so the display devices 12a-12e are not limited to projectors. In other words, the display device of the invention may be a television, a projector or other display device according to practical applications.

As shown in FIG. 2, the remote controller 10 comprises a first processing unit 100, an input unit 102, a first wireless communication unit 104 and a memory unit 106, wherein the first processing unit 100 is electrically connected to the input unit 102, the first wireless communication unit 104 and the memory unit 106. In practical applications, the first processing unit 100 may be a processor or a controller with signal processing function; the input unit 102 may be a keyboard consisting of a plurality of keys, a touch panel or a combination thereof; and the memory unit 106 may be a memory or other data storage devices. In general, the remote controller 10 may be further equipped with some necessary hardware or software components for specific purposes, such as a power supply, an application, an antenna, a circuit board, etc., and it depends on practical applications.

In this embodiment, the input unit 102 comprises a broadcast request key 1020, a plurality of input keys 1022 and a plurality of function keys 1024, wherein the input keys 1022 may comprise alphabetical keys, numeral keys, symbol keys and/or other input keys, and the function keys may comprise volume adjusting key, directional key, enter key and/or other function keys. It should be noted that the number and type of the input keys 1022 and the function keys 1024 may be determined according to practical applications. Furthermore, the application required by the remote controller 10 is stored in the memory unit 106.

As shown in FIG. 2, each of the display devices 12a-12e comprises a second processing unit 120, a display unit 122, a second wireless communication unit 124 and a memory unit 126, wherein the second processing unit 120 is electrically connected to the display unit 122, the second wireless communication unit 124 and the memory unit 126. In practical applications, the second processing unit 120 may be a processor or a controller with signal processing function; and the memory unit 126 may be a memory or other data storage devices. In general, each of the display devices 12a-12e may be further equipped with some necessary hardware or software components for specific purposes, such as a power supply, an application, an antenna, a circuit board, an audio/video input port, a speaker, etc., and it depends on practical applications. When the display devices 12a-12e are projectors, the display unit 122 may be an optical projection module; and when the display devices 12a-12e are televisions, the display unit 122 may be a display panel. Furthermore, the application required by the display devices 12a-12e is stored in the memory unit 126.

The first wireless communication unit 104 and the second wireless communication unit 124 may communicate with each other wirelessly, such that the remote controller 10 may transmit signals to the display devices 12a-12e or receive signals from the display devices 12a-12e. Furthermore, each of the display devices 12a-12e has an identification code ID, wherein the identification code ID may be recorded in the second wireless communication unit 124. For example, when the first wireless communication unit 104 and the second wireless communication unit 124 conform to a Bluetooth communication protocol, the identification code ID may be a Bluetooth device address; and when the first wireless communication unit 104 and the second wireless communication unit 124 conform to a wireless local area network (WEAN) communication protocol, the identification code ID may be a media access control (MAC) address.

When a user wants to pair the remote controller 10 and at least one of the display devices 12a-12e, the user may trigger the broadcast request key 1020 of the remote controller 10 first. When the broadcast request key 1020 of the remote controller 10 is triggered, the first processing unit 100 of the remote controller 10 sends out a broadcast request signal to each of the display devices 12a-12e through the first wireless communication unit 104. When the second processing unit 120 of each of the display devices 12a-12e receives the broadcast request signal through the second wireless communication unit 124, the second processing unit 120 of each of the display devices 12a-12e controls the display unit 122 to display the identification code ID. It should be noted that if the second processing unit 120 of any of the display devices 12a-12e is in off state before receiving the broadcast request signal, the broadcast request signal may switch on the second wireless communication unit 124 of the display devices 12a-12e first and then request the display devices 12a-12e to display their identification codes ID. As shown in FIG. 1, the identification code ID of the display device 12a is rendered by “001”, the identification code ID of the display device 12b is rendered by “002”, the identification code ID of the display device 12c is rendered by “003”, the identification code ID of the display device 12d is rendered by “004”, and the identification code ID of the display device 12e is rendered by “005”. At this time, the user can see the identification code ID corresponding to each of the display devices 12a-12e immediately through the image displayed by each of the display devices 12a-12e. It should be noted that since the display devices 12a-12e shown in FIG. 1 are exemplified by projectors, each of the display devices 12a-12e shown in FIG. 1 projects its own identification code ID on a wall or other projection planes for the user to see.

Afterward, the user may operate the input keys 1022 of the remote controller 10 to input the identification code ID of at least one of the display devices 12a-12e. When the input keys 1022 of the remote controller 10 are operated to input the identification code ID of at least one of the display devices 12a-12e, the remote controller 10 and at least one of the display devices 12a-12e are paired with each other correspondingly. For example, if the user wants to pair the remote controller 10 and the display devices 12a, 12c and 12d, the user may operate the input keys 1022 of the remote controller 10 to input “001”, “003” and “004”. When the user operates the input keys 1022 of the remote controller 10 to input “001”, “003” and “004”, the remote controller 10 and the display devices 12a, 12c and 12d are paired with each other correspondingly. In this embodiment, the user may press the enter key after operating the input keys 1022 of the remote controller 10 to input “001”, “003” and “004”, so as to pair the remote controller 10 and the display devices 12a, 12c and 12d. In another embodiment, the user may wait for a predetermined time period (e.g. three seconds, five seconds, etc.) after operating the input keys 1022 of the remote controller 10 to input “001”, “003” and “004”, so as to pair the remote controller 10 and the display devices 12a, 12c and 12d.

Accordingly, when the input keys 1022 of the remote controller 10 are operated to input the identification code(s) of M of the N display devices, the remote controller 10 and the M display device(s) are paired with each other, wherein M is an integer smaller than or equal to N. Take the aforesaid embodiment for example, N is equal to 5 and M is equal to 3.

It should be noted that the identification code ID displayed by each of the display devices 12a-12e may be the last several digits of the Bluetooth device address or the MAC address (e.g. last two digits, last three digits, etc.), such that the user may operate the input keys 1022 of the remote controller 10 to input the identification code ID of at least one of the display devices 12a-12e rapidly and conveniently. Needless to say, the identification code displayed by each of the display devices 12a-12e may also be whole Bluetooth device address or MAC address. Furthermore, the identification code displayed by each of the display devices 12a-12e may be decimal or hexadecimal according to practical applications.

After pairing the remote controller 10 and the display devices 12a, 12c and 12d, the remote controller 10 may control the display devices 12a, 12c and 12d simultaneously through the first wireless communication unit 104 and the second wireless communication unit 124. For example, the user may operate the function keys 1024 of the remote controller 10 to control the display devices 12a, 12c and 12d to adjust volume, zoom in/out screen and so on simultaneously. Since the remote controller 10 is not paired with the display devices 12b and 12e, the first wireless communication unit 104 of the remote controller 10 does not communicate with the second wireless communication units 124 of the display devices 12b and 12e. Accordingly, the second wireless communication units 124 of the display devices 12b and 12e will not receive control signals from the first wireless communication unit 104 of the remote controller 10. Therefore, the display devices 12b and 12e will not be controlled by the remote controller 10.

When the user wants to pair the remote controller 10 and at least one of the display devices 12a-12e again, the user may trigger the broadcast request key 1020 of the remote controller 10 again. At this time, the previous pairing relation will be reset. Then, the user may pair the remote controller 10 and at least one of the display devices 12a-12e again according to the aforesaid manner. Furthermore, after the remote controller 10 and at least one of the display devices 12a-12e are paired, the display devices 12a-12e may eliminate the displayed identification code ID.

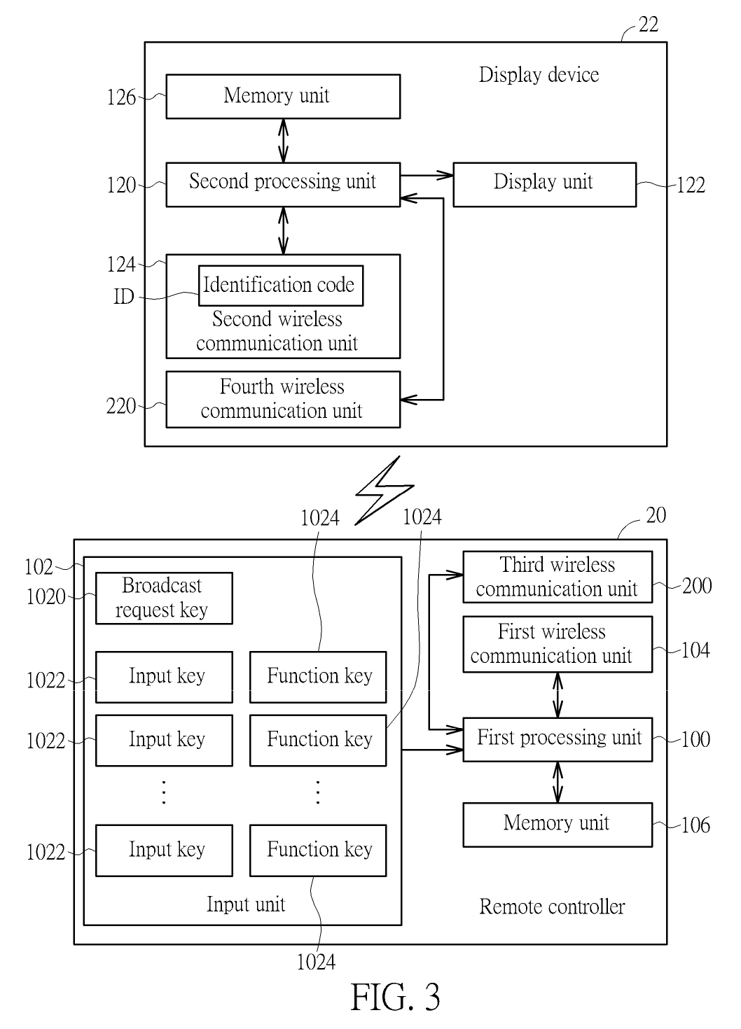

Referring to FIG. 3, FIG. 3 is a functional block diagram illustrating a remote controller 20 and a display device 22 according to another embodiment of the invention. The main difference between the remote controller 20 and the aforesaid remote controller 10 is that the remote controller 20 further comprises a third wireless communication unit 200, wherein the first processing unit 100 is electrically connected to the third wireless communication unit 200. Furthermore, the main difference between the display device 22 and the aforesaid display devices 12a-12e is that the display device 22 further comprises a fourth wireless communication unit 220, wherein the second processing unit 120 is electrically connected to the fourth wireless communication unit 220. In this embodiment, the third wireless communication unit 200 and the fourth wireless communication unit 220 may communicate with each other wirelessly. Still further, the communication protocol of the first wireless communication unit 104 and the second wireless communication unit 124 is different from the communication protocol of the third wireless communication unit 200 and the fourth wireless communication unit 220. For example, if the first wireless communication unit 104 and the second wireless communication unit 124 conform to a Bluetooth communication protocol, the third wireless communication unit 200 and the fourth wireless communication unit 220 may conform to a WLAN communication protocol or an infrared communication protocol; if the first wireless communication unit 104 and the second wireless communication unit 124 conform to a WLAN communication protocol, the third wireless communication unit 200 and the fourth wireless communication unit 220 may conform to a Bluetooth communication protocol or an infrared communication protocol; and so on. It should be noted that the same elements in FIG. 3 and FIG. 2 are represented by the same numerals, so the repeated explanation will not be depicted herein again.

After the remote controller 20 and the display device 22 are paired with each other by the aforesaid manner, the remote controller 20 may control the display device 22 through the third wireless communication unit 200 and the fourth wireless communication unit 220. In other words, in this embodiment, the remote controller 20 and the display device 22 may be paired with each other through the first wireless communication unit 104 and the second wireless communication unit 124 first and then perform function operated by the user through the third wireless communication unit 200 and the fourth wireless communication unit 220. The invention may replace the aforesaid display devices 12a-12e by the display device 22.

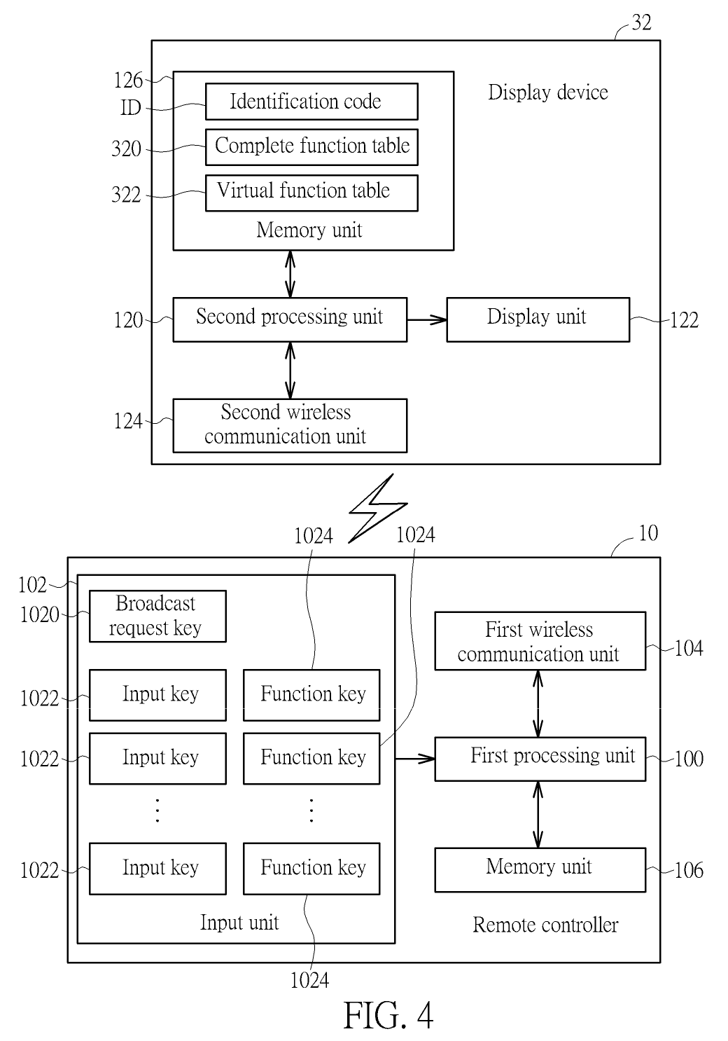

Referring to FIG. 4, FIG. 4 is a functional block diagram illustrating the remote controller 10 and a display device 32 according to another embodiment of the invention. The main difference between the display device 32 and the aforesaid display devices 12a-12e is that the memory unit 126 of the display device 32 further stores a complete function table 320 and a virtual function table 322, and the identification code ID may be stored in the memory unit 126. In this embodiment, the first wireless communication unit 104 and the second wireless communication unit 124 conform to an infrared communication protocol and the identification code ID may be a serial number of the display device 32. The aforesaid serial number is a unique number of the display device 32 assigned by a manufacturer after the display device 32 is manufactured. Furthermore, the complete function table 320 records a plurality of scan codes corresponding to the broadcast request key 1020 and a plurality of control functions, and the virtual function table 322 records another scan code corresponding to the broadcast request key 1020. In other words, other fields of scan codes in the virtual function table 322 are blank (i.e. undefined) except the scan code of the broadcast request key 1020.

The invention may replace the aforesaid display devices 12a-12e by the display device 32. The manner for pairing the remote controller 10 and the display device 32 is substantially the same as the manner for pairing the remote controller 10 and the display devices 12a-12e, so it will not be depicted herein again. In this embodiment, the display device paired with the remote controller 10 executes the complete function table 320 in response to control signals transmitted from the remote controller 10, and the display device not paired with the remote controller 10 executes the virtual function table 322 in response to control signals transmitted from the remote controller 10. Accordingly, when the display device 32 is paired with the remote controller 10, the remote controller 10 may control the display device 32 to execute function operated by the user through the first wireless communication unit 104 and the second wireless communication unit 124 according to the complete function table 320. On the other hand, when the display device 32 is not paired with the remote controller 10, since other fields of scan codes in the virtual function table 322 are blank, the display device 32 will not execute any function even if the display device 32 receives control signals from the remote controller 10.

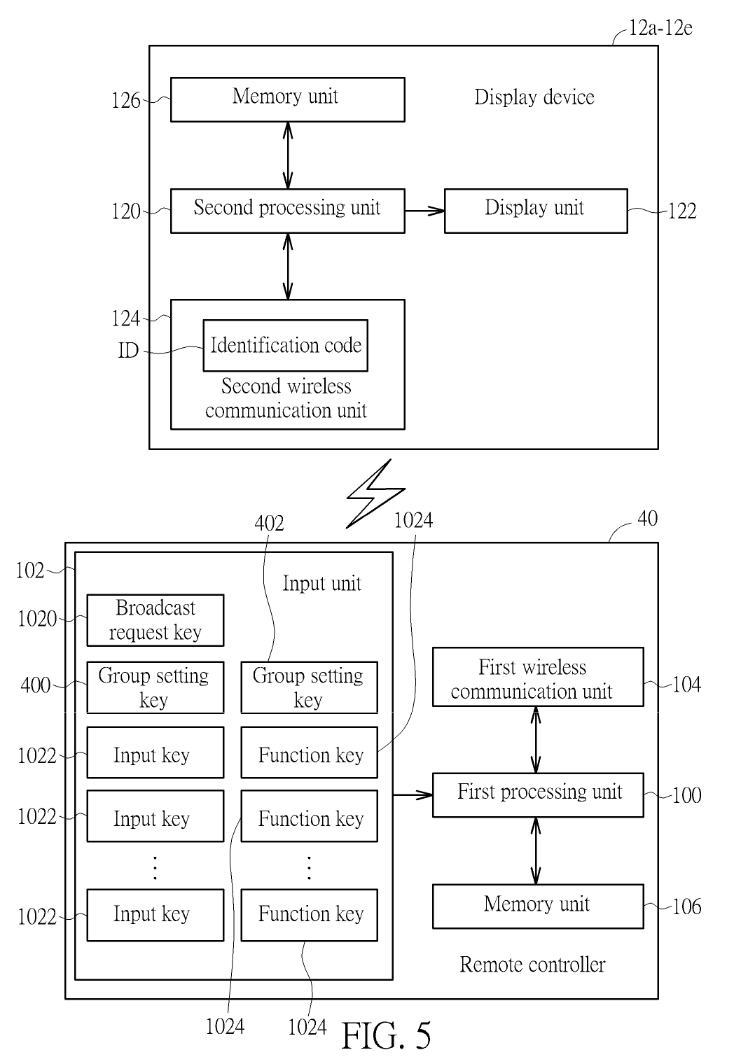

Referring to FIG. 5, FIG. 5 is a functional block diagram illustrating a remote controller 40 and the display devices 12a-12e according to another embodiment of the invention. The main difference between the remote controller 40 and the aforesaid remote controller 10 is that the input unit 102 of the remote controller 40 further comprises at least one group setting key. In this embodiment, the input unit 102 of the remote controller 40 comprises two group setting keys 400, 402. It should be noted that the number of group setting keys may be determined according to practical applications, so it is not limited to two. The group setting keys 400, 402 are used for setting the display device to be paired with the remote controller 10.

For example, the user may use the group setting key 400 to set the display device 12a to be paired with the remote controller 10 according to the aforesaid manner and use the group setting key 402 to set the display devices 12b, 12c and 12d to be paired with the remote controller 10 according to the aforesaid manner. When the user wants to use the remote controller 10 to control the display device 12a, the user only has to trigger the group setting key 400 and needs not to perform the aforesaid pairing operation. Similarly, when the user wants to use the remote controller 10 to control the display devices 12b, 12c and 12d, the user only has to trigger the group setting key 402 and needs not to perform the aforesaid pairing operation.

Take FIG. 1 for example, the user may press the group setting key 400 after operating the input keys 1022 of the remote controller 10 to input “001”, so as to pair the remote controller 10 and the display device 12a. In another embodiment, the user may press the group setting key 400 first, operate the input keys 1022 of the remote controller 10 to input “001”, and then wait for a predetermined time period (e.g. three seconds, five seconds, etc.), so as to pair the remote controller 10 and the display device 12a. The manner for operating the group setting key 402 is the same as the manner for operating the group setting key 400, so it will not be depicted herein again.

When the group setting key 400 is triggered, the display device 12a paired with the remote controller 10 may send out a sound, a light and/or a projection, such that the user may notice the display device 12a that he/she wants to control. Similarly, the group setting key 402 is triggered, the display devices 12b, 12c and 12d paired with the remote controller 10 may send out a sound, a light and/or a projection, such that the user may notice the display devices 12b, 12c and 12d that he/she wants to control.

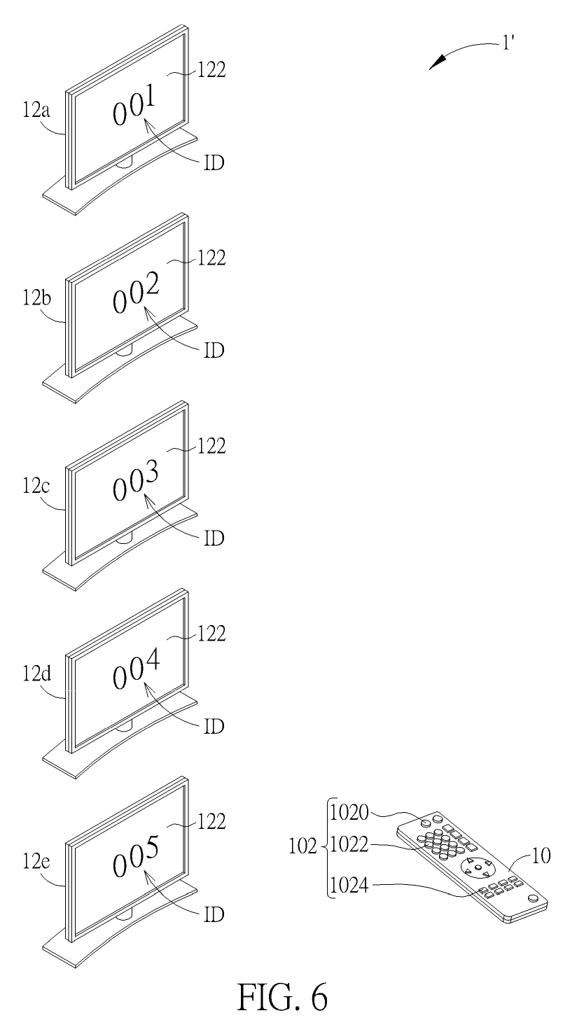

Referring to FIG. 6, FIG. 6 is a schematic diagram illustrating a wireless pairing system 1′ according to another embodiment of the invention. The main difference between the wireless pairing system 1′ and the aforesaid wireless pairing system 1 is that the display devices 12a-12e of the wireless pairing system 1′ are televisions. Accordingly, in this embodiment, when the broadcast request key 1020 of the remote controller 10 is triggered, the display devices 12a-12e display the identification code ID on the display unit 122 directly.

As mentioned in the above, when a user wants to pair the remote controller and the display device, the user may trigger the broadcast request key of the remote controller first, so as to send out the broadcast request signal to the display device. When the display device receives the broadcast request signal, the display unit of the display device will display the identification code. At this time, the user may operate the input keys of the remote controller to input the identification code of the display device, so as to pair the remote controller and the display device. Accordingly, the wireless pairing system of the invention is capable of pairing the remote controller and the display device rapidly and conveniently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless pairing system comprising:
a remote controller comprising a first processing unit, an input unit and a first wireless communication unit, the first processing unit being electrically connected to the input unit and the first wireless communication unit, the input unit comprising a broadcast request key and a plurality of input keys; and
at least one display device, the display device comprising a second processing unit, a display unit and a second wireless communication unit, the second processing unit being electrically connected to the display unit and the second wireless communication unit, the first wireless communication unit and the second wireless communication unit communicating with each other wirelessly, the display device having an identification code;
wherein when the broadcast request key of the remote controller is triggered, the first processing unit of the remote controller sends out a broadcast request signal through the first wireless communication unit; when the second processing unit of the display device receives the broadcast request signal through the second wireless communication unit, the second processing unit of the display device controls the display unit to display the identification code; when the input keys of the remote controller are operated to input the identification code of the display device, the remote controller and the display device are paired with each other.

2. The wireless pairing system of claim 1, wherein the first wireless communication unit and the second wireless communication unit conform to a Bluetooth communication protocol and the identification code is a Bluetooth device address.

3. The wireless pairing system of claim 1, wherein the first wireless communication unit and the second wireless communication unit conform to a wireless local area network communication protocol and the identification code is a media access control address.

4. The wireless pairing system of claim 1, wherein the first wireless communication unit and the second wireless communication unit conform to an infrared communication protocol, the identification code is a serial number of the display device, the display device further comprises a memory unit, and the second processing unit is electrically connected to the memory unit.

5. The wireless pairing system of claim 4, wherein the memory unit stores a complete function table and a virtual function table, the complete function table records a plurality of scan codes corresponding to the broadcast request key and a plurality of control functions, the virtual function table records another scan code corresponding to the broadcast request key, the display device paired with the remote controller executes the complete function table in response to control signals transmitted from the remote controller, and the display device not paired with the remote controller executes the virtual function table in response to control signals transmitted from the remote controller.

6. The wireless pairing system of claim 1, wherein the input unit further comprises at least one group setting key and the group setting key is used for setting the display device to be paired with the remote controller.

7. The wireless pairing system of claim 6, wherein when the group setting key is triggered, the display device paired with the remote controller sends out a sound, a light and/or a projection.

8. The wireless pairing system of claim 1, wherein the display device is a television or a projector.

9. The wireless pairing system of claim 1, wherein after the remote controller and the display device are paired with each other, the remote controller controls the display device through the first wireless communication unit and the second wireless communication unit.

10. The wireless pairing system of claim 1, wherein the remote controller further comprises a third wireless communication unit, the first processing unit is electrically connected to the third wireless communication unit, the display device further comprises a fourth wireless communication unit, the second processing unit is electrically connected to the fourth wireless communication unit, the third wireless communication unit and the fourth wireless communication unit communicates with each other wirelessly, a communication protocol of the first wireless communication unit and the second wireless communication unit is different from a communication protocol of the third wireless communication unit and the fourth wireless communication unit, after the remote controller and the display device are paired with each other, the remote controller controls the display device through the third wireless communication unit and the fourth wireless communication unit.

11. The wireless pairing system of claim 1, wherein the at least one display device comprises N display devices, when the input keys of the remote controller are operated to input the identification code(s) of M of the N display devices, the remote controller and the M display device(s) are paired with each other, N is an integer larger than 1, and M is an integer smaller than or equal to N.
